(19) United States
(12) Patent Application Publication
(10) Pub. No.: US 2025/0182407 A1
(43) Pub. Date: Jun. 5, 2025

(54) INFORMATION PROCESSING APPARATUS, INFORMATION PROCESSING METHOD, AND STORAGE MEDIUM

(71) Applicant: NEC Corporation, Tokyo (JP)

(72) Inventors: Mamoru HIROTA, Tokyo (JP); Takashi NONAKA, Tokyo (JP); Kentaro NISHIDA, Tokyo (JP)

(73) Assignee: NEC Corporation, Tokyo (JP)

(21) Appl. No.: 18/958,029

(22) Filed: Nov. 25, 2024

(30) Foreign Application Priority Data
Dec. 5, 2023 (JP) 2023-205571

(51) Int. Cl. G06T 19/00

(52) U.S. Cl. CPC G06T 19/003

(57) ABSTRACT

An information processing apparatus includes at least one processor. The at least one processor carries out: a spatial information obtaining process of obtaining spatial information that includes information related to an object present in a three-dimensional space; and a position determination process of determining a position of the object present in the three-dimensional space with use of a plurality of planes, the plurality of planes being normal to respective axes that are independent of each other and being defined to traverse the entirety of the three-dimensional space.

This Nonprovisional application claims priority under 35 U.S.C. § 119 on Patent Application No. 2023-205571 filed in Japan on Dec. 5, 2023, the entire contents of which are hereby incorporated by reference.

### TECHNICAL FIELD

The present disclosure relates to an information processing apparatus, an information processing method, and a storage medium.

### BACKGROUND ART

Techniques related to the virtual three-dimensional space are known. For example, Patent Literature 1 discloses a game apparatus for controlling movement of a character placed in the virtual three-dimensional space. The game apparatus carries out a process of determining the position (x,y,z) and rotational angles (angles about the x-axis, y-axis, and z-axis) of an object, such as a character, and then carries out, for example, a process of detecting collision between objects.

### CITATION LIST

### Patent Literature

[Patent Literature 11
Japanese Patent Application Publication Tokukai No. 2010-63844

### SUMMARY OF INVENTION

### Technical Problem

In recent years, there has been an increasing number of services utilizing the three-dimensional space, such as stores for shopping, besides games. Thus, platforms for easily providing services utilizing the three-dimensional space have also been developed. However, such a platform does not necessarily notify a user using the platform about the position of an object present in the three-dimensional space. Thus, if the user using the platform wants to determine the position of the object, the user needs to carry out a process of determining the position of the object.

For example, it is assumed that a case where the method disclosed in Patent Literature 1 is used to determine the position of an object, such as a character, present in the three-dimensional space. In this case, it is necessary to define the x-, y-, and z-axes, and determine the coordinates at which the object is present for each axis. In this configuration, for example, in a case where the coordinates 0 to 100 are assigned to each axis, the required number of times the processing is executed will be 100×100×100=1000000 times in order to determine the position of the object with use of the coordinates. Thus, to determine the position of an object present in the three-dimensional space by the method disclosed in Patent Literature 1, there is a problem in that the processing load might be too high.

The present disclosure has been made in view of this problem, and an example object thereof is to provide a technique for reducing a load of a process of determining the position of an object present in the three-dimensional space.

### Solution to Problem

An information processing apparatus in accordance with an example aspect of the present disclosure, includes at least one processor, the at least one processor carrying out: a spatial information obtaining process of obtaining spatial information that includes information related to a virtual three-dimensional space and related to an object present in the three-dimensional space; and a position determination process of determining a position of the object present in the three-dimensional space with reference to the spatial information with use of a plurality of planes, the plurality of planes being normal to respective axes that are independent of each other in the three-dimensional space and being defined to traverse an entirety of the three-dimensional space.

An information processing method in accordance with an example aspect of the present disclosure, includes: a spatial information obtaining process in which at least one processor obtains spatial information that includes information related to a virtual three-dimensional space and related to an object present in the three-dimensional space; and a position determination process in which the at least one processor determines a position of the object present in the three-dimensional space with reference to the spatial information with use of a plurality of planes, the plurality of planes being normal to respective axes that are independent of each other in the three-dimensional space and being defined to traverse an entirety of the three-dimensional space.

A storage medium in accordance with an example aspect of the present disclosure is a non-transitory storage medium storing a program for causing a computer to function as an information processing apparatus, the program carrying out: a spatial information obtaining process of obtaining spatial information that includes information related to a virtual three-dimensional space and related to an object present in the three-dimensional space; and a position determination process of determining a position of the object present in the three-dimensional space with reference to the spatial information with use of a plurality of planes, the plurality of planes being normal to respective axes that are independent of each other in the three-dimensional space and being defined to traverse an entirety of the three-dimensional space.

### Advantageous Effects of Invention

According to an example aspect of the present disclosure, it is possible to achieve an example advantage of being capable of providing a technique for reducing a load of a process of determining the position of an object present in the three-dimensional space.

### BRIEF DESCRIPTION OF DRAWINGS

FIG. 1 is a block diagram illustrating the configuration of an information processing apparatus in accordance with the present disclosure.

FIG. 2 is a flowchart illustrating the flow of an information processing method in accordance with the present disclosure.

FIG. 3 is a diagram illustrating an example of a three-dimensional space in accordance with the present disclosure.

FIG. 4 is a block diagram illustrating the configuration of an information processing apparatus in accordance with the present disclosure.

FIG. 5 is a diagram illustrating an example of a spatial ID assigned by an assignment section in accordance with the present disclosure.

FIG. 6 is a flowchart illustrating the flow of an information processing method in accordance with the present disclosure.

FIG. 7 illustrates an example of a plane that is normal to the z-axis in the three-dimensional space in accordance with the present disclosure, and has a z coordinate of 1.

FIG. 8 is a diagram illustrating an example of a history outputted from the output section in accordance with the present disclosure.

FIG. 9 is a block diagram illustrating the configuration of a computer that functions as the information processing apparatus in accordance with the present disclosure.

### EXAMPLE EMBODIMENTS

Example embodiments of the present invention will be described below by way of example. It should be noted that the present invention is not limited to the example embodiments described below, but may be altered in various ways by a skilled person within the scope of the claims. For example, any example embodiment derived by appropriately combining technical means employed in the example embodiments described below can be within the scope of the present invention. Further, any example embodiment derived from appropriately omitting some of the technical means employed in the example embodiments described below can also be within the scope of the present invention. Furthermore, an example advantage to which reference is made in each of the example embodiments described below is an example of the advantage expected in that example embodiment, and does not define the extension of the present invention. Therefore, any example embodiment which does not provide the example advantage to which reference is made in each of the example embodiments described below can also be within the scope of the present invention.

### First Example Embodiment

A first example embodiment, which is an example of an embodiment of the present invention, will be described in detail with reference to the drawings. The present example embodiment is a basic form of each example embodiment discussed later. It should be noted that the scope of an application of technical means employed in the present example embodiment is not limited to the present example embodiment. That is, each technical means employed in the present example embodiment can be employed also in another example embodiment included in the present disclosure, provided that no particular technical problems occur. In addition, each technical means indicated in the drawings referred to for discussing the present example embodiment can be employed also in another example embodiment included in the present disclosure, provided that no particular technical problems occur.

### (Configuration of Information Processing Apparatus 1)

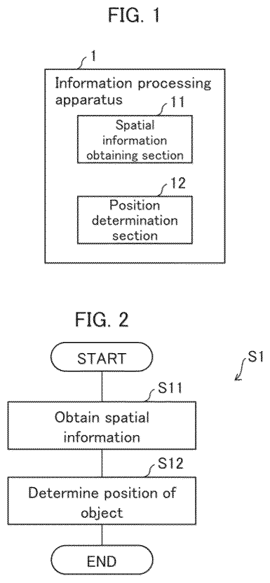

The following will describe the configuration of an information processing apparatus 1 with reference to FIG. 1. FIG. 1 is a block diagram illustrating the configuration of the information processing apparatus 1. As illustrated in FIG. 1, the information processing apparatus 1 includes a spatial information obtaining section 11 and a position determination section 12. In the present example embodiment, the spatial information obtaining section 11 implements spatial information obtaining means, and the position determination section 12 implements position determination means.

The spatial information obtaining section 11 obtains spatial information that includes information related to a virtual three-dimensional space (hereinafter, the “virtual three-dimensional space” may also be referred to simply as the “three-dimensional space”) and related to an object present in the three-dimensional space. The spatial information obtaining section 11 provides the obtained spatial information to the position determination section 12.

The position determination section 12 determines the position of the object present in the three-dimensional space with reference to the spatial information obtained by the spatial information obtaining section 11, with use of a plurality of planes, the plurality of planes being normal to respective axes that are independent of each other in the three-dimensional space and being defined to traverse the entirety of the three-dimensional space.

The “axes that are independent of each other” means that every pair of the axes are not parallel, and every axis intersects a plane or planes formed by the other axis or axes. Some of or all of the coordinate systems defined by the “axes that are independent of each other” may be the oblique coordinate system or the spherical coordinate system.

For example, the “plurality of planes being normal to respective axes that are independent of each other” may be one plane normal to the x-axis and one plane normal to the y-axis in a case where the x-axis and the y-axis are employed as the axes. That is, the “plurality of planes” in the present example may be constituted by a set of planes normal to respective axes.

As another example, the “plurality of planes normal to respective axes that are independent of each other” may be a group of one or more planes normal to the x-axis and a group of one or more planes normal to the y-axis in a case where the x-axis and the y-axis are employed as the axes. In this case, the “plurality of planes being normal to respective axes that are independent of each other” may also be expressed as the “plurality of groups of planes each normal to a corresponding one of the axes that are independent of each other”.

### (Example Advantage of Information Processing Apparatus 1)

As described in the foregoing, the information processing apparatus 1 employs a configuration of including: the spatial information obtaining section 11 that obtains spatial information that includes information related to a virtual three-dimensional space and related to an object present in the three-dimensional space; and the position determination section 12 that determines the position of the object present in the three-dimensional space with reference to the spatial information obtained by the spatial information obtaining section 11, with use of a plurality of planes, the plurality of planes being normal to respective axes that are independent of each other in the three-dimensional space and being defined to traverse an entirety of the three-dimensional space.

Thus, with the information processing apparatus 1, it is possible to achieve an example advantage of being capable of reducing the load of the process of determining the position of an object present in the three-dimensional space.

### (Flow of Information Processing Method S1)

The following will describe the flow of an information processing method S1 with reference to FIG. 2. FIG. 2 is a flowchart illustrating the flow of the information processing method S1. As illustrated in FIG. 2, the information processing method S1 includes a spatial information obtaining process S11 and a position determination process S12.

### (Spatial Information Obtaining Process S11)

In the spatial information obtaining process S11, the spatial information obtaining section 11 obtains spatial information that includes information related to a virtual three-dimensional space and related to an object present in the three-dimensional space. The spatial information obtaining section 11 provides the obtained spatial information to the position determination section 12.

### (Position Determination Process S12)

In the position determination process S12, the position determination section 12 determines the position of the object present in the three-dimensional space with reference to the spatial information obtained by the spatial information obtaining section 11, with use of a plurality of planes, the plurality of planes being normal to respective axes that are independent of each other in the three-dimensional space and being defined to traverse the entirety of the three-dimensional space.

### (Example Advantage of Information Processing Method S1)

As described in the foregoing, the information processing method S1 employs a configuration of including: the spatial information obtaining process S11 of obtaining, by the spatial information obtaining section 11, spatial information that includes information related to a virtual three-dimensional space and related to an object present in the three-dimensional space; and the position determination process S12 of determining, by the position determination section 12, the position of the object present in the three-dimensional space with reference to the spatial information obtained by the spatial information obtaining section 11, with use of a plurality of planes, the plurality of planes being normal to respective axes that are independent of each other in the three-dimensional space and being defined to traverse an entirety of the three-dimensional space. Thus, with the information processing method S1, it is possible to achieve an example advantage similar to that achieved by the information processing apparatus 1 described above.

### Second Example Embodiment

A second example embodiment, which is an example of the embodiment of the present invention, will be described in detail with reference to the drawings. The same reference symbols are given to constituent elements which have functions identical to those described in the above example embodiment, and descriptions as to such constituent elements are omitted as appropriate. It should be noted that the scope of an application of technical means employed in the present example embodiment is not limited to the present example embodiment. That is, each technical means employed in the present example embodiment can be employed also in another example embodiment included in the present disclosure, provided that no particular technical problems occur. In addition, each technical means illustrated in each drawing referred to for discussing the present example embodiment can be employed also in another example embodiment included in the present disclosure, provided that no particular technical problems occur.

### (Outline of Information Processing Apparatus 1A)

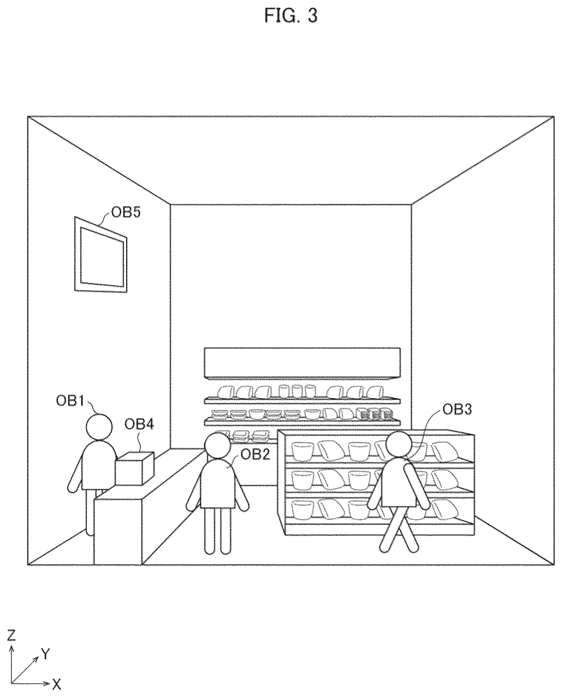

The information processing apparatus 1A is an apparatus for providing a virtual three-dimensional space by using a platform that generates the virtual three-dimensional space. In accordance with an instruction from a user who uses the three-dimensional space, the information processing apparatus 1A causes an object (e.g., a person, a device, goods, etc.) present in the three-dimensional space to move and causes an object present in the three-dimensional space to operate. Further, the information processing apparatus 1A determines the position of an object present in the three-dimensional space. An example of the three-dimensional space in accordance with the present disclosure is depicted in FIG. 3. FIG. 3 is a diagram illustrating an example of the three-dimensional space.

The three-dimensional space illustrated in FIG. 3 is a store where goods, which are objects included in the three-dimensional space, are sold. As an example, in the three-dimensional space illustrated in FIG. 3, a salesclerk OB1 who sells goods, a customer OB2, a customer OB3, a register OB4, and a display OB5 are present. For example, if the information processing apparatus 1A receives an instruction from a user who operates the customer OB2 to move the customer OB2 to the left, the information processing apparatus 1A moves the customer OB2 to the left in the three-dimensional space. As another example, if the information processing apparatus 1A receives an instruction from a user who operates the salesclerk OB1 to operate the register OB4, the information processing apparatus 1A causes the salesclerk OB1 to operate the register OB4 in the three-dimensional space. Further, the information processing apparatus 1A determines the positions of the salesclerk OB1, the customer OB2, the customer OB3, the register OB4, and the display OB5 in the three-dimensional space. Other examples of the three-dimensional space in accordance with the present disclosure may include, but not limited to, an airport and a school.

### (Configuration of Information Processing Apparatus 1A)

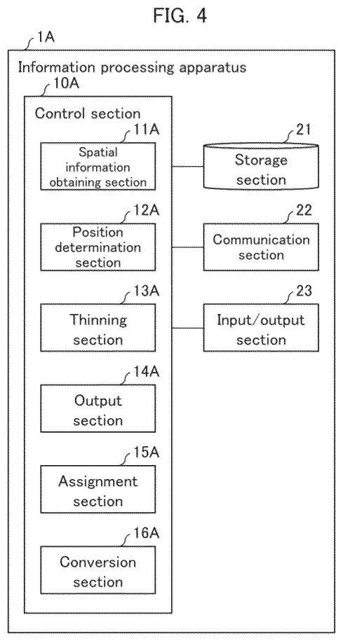

The following will describe the configuration of the information processing apparatus 1A with reference to FIG. 4. FIG. 4 is a block diagram illustrating the configuration of the information processing apparatus 1A. The information processing apparatus 1A includes a control section 10A, a storage section 21, a communication section 22, and an input/output section 23.

The storage section 21 stores data referred to by the control section 10A. Examples of the data stored in the storage section 21 may include spatial information and sensor information, which will be described later. Examples of the storage section 21 may include, but not limited to, a flash memory, a hard disk drive (HDD), a solid state drive (SSD), and a combination thereof.

The communication section 22 is an interface for performing transmission and reception of data via a network. For example, the communication section 22 may transmit data provided by the control section 10A to another apparatus and provide data received from another apparatus to the control section 10A. Examples of the communication section 22 may include, but not limited to, a communication chip in various communication standards such as Ethernet (registered trademark), Wi-Fi (registered trademark), and radio communications standard for mobile data communications networks, and a USB-compliant connector.

The input/output section 23 is an interface for receiving data input and for outputting data. After receiving data input, the input/output section 23 provides received data to the control section 10A. The input/output section 23 also outputs data provided from the control section 10A. Examples of the input/output section 23 may include, but not limited to, a keyboard, a mouse, a touch pad, a microphone, and a liquid crystal display.

### (Control Section 10A)

The control section 10A controls constituent elements included in the information processing apparatus 1A.

As illustrated in FIG. 4, the control section 10A includes a spatial information obtaining section 11A, a position determination section 12A, a thinning section 13A, an output section 14A, an assignment section 15A, and a conversion section 16A. In the present example embodiment, the spatial information obtaining section 11A, the position determination section 12A, the thinning section 13A, the output section 14A, the assignment section 15A, and the conversion section 16A implement the spatial information obtaining means, the position determination means, thinning means, output means, assignment means, and conversion means, respectively.

The spatial information obtaining section 11A obtains spatial information that includes information related to a virtual three-dimensional space and related to an object present in the three-dimensional space. The spatial information obtaining section 11A stores the obtained spatial information in the storage section 21.

Examples of the information related to an object may include, but not limited to, identification information for distinguishing the object from others (hereinafter, the identification information is also referred to as “object ID”), information indicating that the object is present in the three-dimensional space, information indicating that the object has entered the three-dimensional space, information indicating that the object has moved in the three-dimensional space, and information indicating the behavior of the object.

The spatial information may include information other than the information related to an object present in the three-dimensional space. Examples of the information included in the spatial information may include, but not limited to, information related to time.

The position determination section 12A determines the position of an object present in the three-dimensional space with reference to the spatial information stored in the storage section 21, with use of a plurality of planes, the plurality of planes being normal to respective axes that are independent of each other and being defined to traverse the entirety of the three-dimensional space. The axes that are independent of each other and the plurality of planes are as described above.

The position determination section 12A stores the information indicating the determined position in the storage section 21. In a case where the spatial information includes the object ID, the position determination section 12A may store, in the storage section 21, the information indicating the position of an object in accordance with the object ID of the object. In a case where the spatial information includes information indicating time, the position determination section 12A may store, in the storage section 21, the time in accordance with the information indicating the position of an object. An example process carried out by the position determination section 12A will be described later.

With reference to the spatial information, the thinning section 13A reduces a frequency of the process of determining the position of an object carried out by the position determination section 12A. In other words, the thinning section 13A specifies at least either the determination timing or the determination area for determining the position of the object, to the position determination section 12A. An example process carried out by the thinning section 13A will be described later.

The output section 14A outputs data to the communication section 22, the input/output section 23, or the storage section 21. For example, the output section 14A may output the position of the object determined by the position determination section 12A. As another example, the output section 14A may output the history of the position determined by the position determination section 12A in a predetermined period. As another example, the output section 14A may output at least one selected from the group consisting of the movement of the object, the instruction to the object, and the distance between objects. An example data outputted from the output section 14A will be described later.

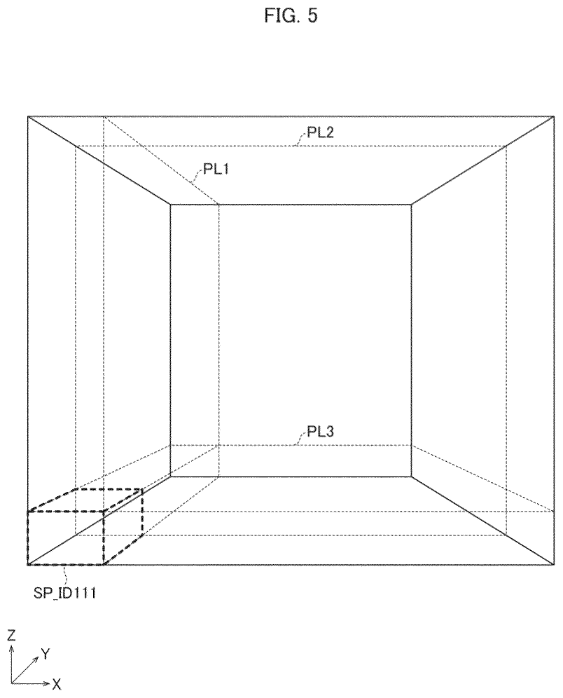

The assignment section 15A assigns, to each of a plurality of spaces defined by a plurality of planes, spatial identification information for distinguishing the space from others (hereinafter, the spatial identification information is also referred to as “spatial ID”). An example of the spatial ID assigned by the assignment section 15A will be described with reference to FIG. 5. FIG. 5 is a diagram illustrating an example of the spatial ID assigned by the assignment section 15A.

In FIG. 5, as the axes that are independent of each other, the x-axis in the right-and-left direction, the y-axis in the front-to-back direction, and the z-axis in the vertical direction are provided as illustrated in the lower left corner of FIG. 5. Also, in FIG. 5, plane PL1 normal to the x-axis, plane PL2 normal to the y-axis, and plane PL3 normal to the z-axis are depicted. Here, the planes PL1, PL2, and PL3 depicted in FIG. 5 are virtual planes, and are invisible planes in the three-dimensional space provided to a user by the information processing apparatus 1A, as illustrated in FIG. 3.

As described above, the “plurality of planes” may be the planes PL1, PL2, and PL3 illustrated in FIG. 5, or alternatively, may be groups each including one or more planes normal to a corresponding axis. An example of a group of one or more planes may be: plane PL1 normal to the x-axis; plane PL1_1 spaced apart from the plane PL1 by a predetermined distance (e.g., 1 in coordinate units) in the positive direction of the x-axis; and plane PL1_2 spaced apart from the plane PL1_1 by a predetermined distance in the positive direction of the x-axis. However, the predetermined distance and the number of planes are not particularly limited thereto.

As an example, in the three-dimensional space illustrated in FIG. 5, the assignment section 15A assigns spatial identification information SP_ID111 to a space defined by the planes PL1, PL2, and PL3. As another example, although not illustrated in FIG. 5, the assignment section 15A may assign spatial identification information SP_ID211 to a space defined by the plane PL1, the plane PL1_1 normal to the x-axis and spaced apart from the plane PL1 by a predetermined distance in the positive direction of the x-axis, the plane PL2, and the plane PL3. As another example, although not illustrated in FIG. 5, the assignment section 15A may assign spatial identification information SP_ID121 to a space defined by the plane PL1, the plane PL2, plane PL2_1 normal to the y-axis and spaced apart from the plane PL2 by a predetermined distance in the positive direction of the y-axis, and the plane PL3.

In this way, the assignment section 15A assigns the spatial ID to each space included in the three-dimensional space. This enables the information processing apparatus 1A to determine the position of an object included in the three-dimensional space by means of the spatial ID. For example, even if an object is placed in the three-dimensional space in a floating manner, as the display OB5 is in FIG. 3, it is possible to determine the position of the object by associating the position with the spatial ID.

The conversion section 16A refers to the sensor information outputted from a sensor that detects an object in the real space, and converts the position of the object to the spatial ID. For example, in a case where a store in the three-dimensional space illustrated in FIG. 3 is a digital recreation of a physical store in the real space made to exist in the three-dimensional space, the conversion section 16A obtains the sensor information outputted from a sensor disposed in the physical store. The type of the sensor disposed in the store is not particularly limited, and examples thereof may include a camera and a motion sensor.

For example, in a case where the conversion section 16A obtains images of the inside of the store from respective cameras disposed in the store, the conversion section 16A may detect an object inside the store by using a known object detection technique. Further, the conversion section 16A may refer to the images obtained from the cameras, to determine the position of the detected object by using a known distance measurement technique. Then, the conversion section 16A may convert the determined position into the spatial ID.

In this way, the conversion section 16A can recreate the real space including the object in the virtual three-dimensional space. For example, to analyze the physical store in the real space to find out a place where the customer's stay ratio is high and a place where the volume of customer passage is large, it is necessary to observe the physical store for a long time or to watch videos taken of the physical store. In contrast, since the information processing apparatus 1A can recreate, in the three-dimensional space, the physical store in the real space and can determine the position of the object, it is possible to provide a user with information for analyzing the store to find out a place where the customer's stay ratio is high and a place where the volume of customer passage is large.

### (Processes Carried Out by Information Processing Apparatus 1A)

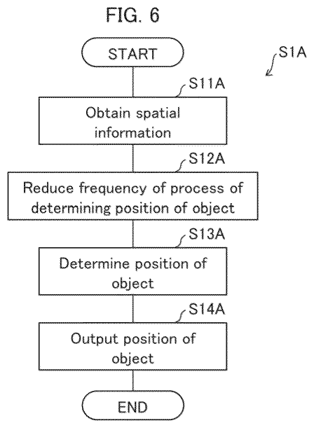

The following will describe the flow of processes carried out by the information processing apparatus 1A (information processing method S1A) with reference to FIG. 6. FIG. 6 is a flowchart illustrating the flow of the information processing method S1A. Although the processes carried out by the assignment section 15A and the conversion section 16A are not illustrated in FIG. 6, the assignment section 15A and the conversion section 16A carry out these processes before step S11A.

### (Step S11A)

In step S11A, the spatial information obtaining section 11A obtains spatial information. As described above, the spatial information obtaining section 11A may obtain spatial information that includes, in addition to information related to an object present in the three-dimensional space, information other than the information related to an object present in the three-dimensional space.

### (Step S12A)

In step S12A, with reference to the spatial information, the thinning section 13A reduces the frequency of a process of determining the position of the object carried out by the position determination section 12A.

### (Step S13A)

In step S13A, the position determination section 12A determines the position of the object at the frequency of the process reduced by the thinning section 13A.

### (Step S14A)

In step S14A, the output section 14A outputs the position of the object determined by the position determination section 12A.

### (Example of Process Carried Out by Position Determination Section 12A)

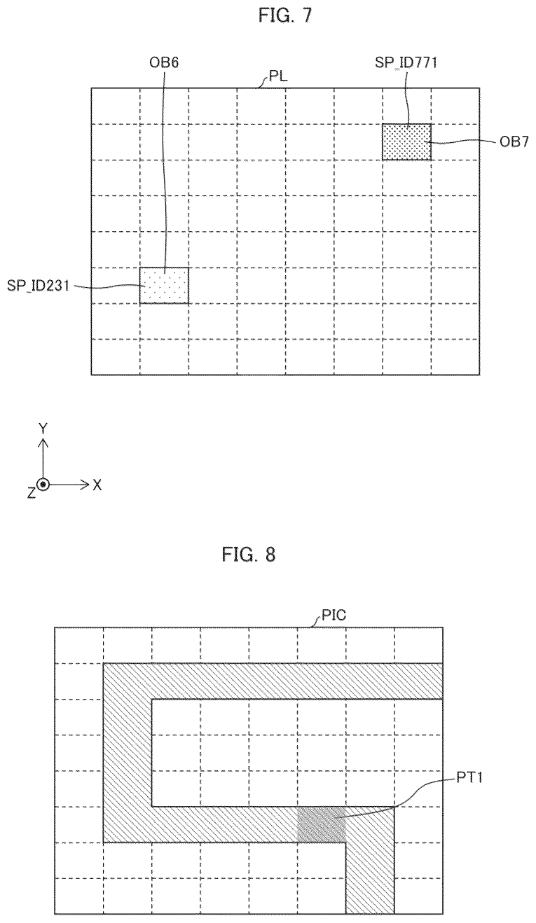

As an example, the position determination section 12A determines the positional relationship between the object and a plane of a plurality of planes defined to traverse the entirety of the three-dimensional space, to determine the position of the object with respect to the normal of the plane. This process will be described hereunder with reference to FIG. 7.

FIG. 7 is an example of a plane PL that is normal to the z-axis in the three-dimensional space and has a z coordinate of 1.

First, the position determination section 12A determines whether the plane PL includes any objects (whether the plane PL is in contact with any objects). In FIG. 7, the plane PL includes object OB6 and object OB7. Similarly, as for a plane that is normal to the z-axis and has a z coordinate of 2, the position determination section 12A also determines whether this plane includes any objects. The position determination section 12A carries out this process for the entire three-dimensional space.

Next, the position determination section 12A determines whether a plane that is normal to the x-axis and has an x coordinate of 1 includes any objects. In FIG. 7, the plane having an x coordinate of 1 and a plane having an x coordinate of 2 include the object OB6, and a plane having an x coordinate of 6 and a plane having an x coordinate of 7 include the object OB7. The position determination section 12A carries out this process for the entire three-dimensional space.

Similarly, the position determination section 12A determines whether a plane that is normal to the y-axis and has a y coordinate of 1 includes any objects. In FIG. 7, a plane having a y coordinate of 2 and a plane having a y coordinate of 3 include the object OB6, and a plane having a y coordinate of 6 and a plane having a y coordinate of 7 include the object OB7. The position determination section 12A carries out this process for the entire three-dimensional space.

Then, the position determination section 12A determines the position of the objects. In the three-dimensional space illustrated in FIG. 7, the position determination section 12A determines that the object OB6 is present at (x,y,z)=(1,2,1), (2,2,1), (1,3,1), (2,3,1). Similarly, the position determination section 12A determines that the object OB7 is present at (x,y,z)=(6,6,1), (7,6,1), (6,7,1), (7,7,1).

The position determination section 12A may determine the position of the object by using the spatial ID assigned by the assignment section 15A. In this case, in FIG. 7, the position determination section 12A determines that the object OB6 is present at spatial identification information SP_ID231. The position determination section 12A also determines that the object OB7 is present at spatial identification information SP_ID771.

In this way, the position determination section 12A determines the positional relationship between an object and a plane of the plurality of planes defined to traverse the entirety of the three-dimensional space, to determine the position of the object with respect to the normal of the plane.

For example, in a case where it is assumed that the x-, y-, and z-axes run in a three-dimensional space and coordinates 0 to 100 are assigned thereto, and if the object position is determined with use of coordinates, it is necessary to execute the process 100×100×100=1000000 times. In contrast, since the position determination section 12A determines the object position with use of planes, it is possible to determine the object position by the process carried out 100×3=300 times. Therefore, the position determination section 12A can reduce the load of the process of determining the position of an object present in the three-dimensional space.

### (Example 1 of Process Carried Out by Thinning Section 13A)

As an example, the thinning section 13A increases the time interval between runs of the process of determining the position carried out by the position determination section 12A so as to make the time interval longer than a predetermined time interval.

For example, it is assumed that the position determination section 12A carries out the process of determining the position at intervals of one second. As an example of this case, in a case where the spatial information includes information related to the movement of the object, and this information indicates that the object has not moved by more than a certain distance, the thinning section 13A reduces the frequency of the process so that the position determination section 12A carries out the process of determining the position at intervals of three seconds.

Thus, the thinning section 13A refers to the spatial information and increases the time interval between runs of the process of determining the position carried out by the position determination section 12A so as to make the time interval longer than a predetermined time interval. In other words, the thinning section 13A controls the frequency relating to time at which the position determination section 12A carries out the process of determining the position. Thus, the thinning section 13A can reduce the load of the process of determining the position of an object present in the three-dimensional space.

### (Example 2 of Process Carried Out by Thinning Section 13A)

As another example, with regard to an object the position of which has been determined, if the position determination section 12A determines the position of the object again after a predetermined period of time has elapsed, the thinning section 13A causes the position determination section 12A to determine the position of the object with use of a plane which is included in a predetermined area defined with respect to the previously determined position.

For example, as illustrated in FIG. 7, it is assumed that a predetermined period of time has elapsed since the position determination section 12A determines that the object OB6 is present at the spatial identification information SP_ID231, and the position of the object OB6 is determined again. In this case, the thinning section 13A causes the position determination section 12A to determine the position of the object OB6 with use of a plane which is included in the predetermined area defined with respect to the previously determined spatial identification information SP_ID231. Examples of the predetermined area may include, but not particularly limited to, a plane in contact with the space of the spatial identification information SP_ID231 and a plane spaced apart from the space of the spatial identification information SP_ID231 by not more than 2 in coordinate units.

As another example, it is assumed that two or more stories (e.g., the first floor and the second floor) are formed in the three-dimensional space. In this case, the thinning section 13A causes the position determination section 12A to determine the position of an object for each story.

In this configuration, the thinning section 13A may cause the position determination section 12A to determine the position of an object in the story identical to that corresponding to the previously determined position. For example, it is assumed that a predetermined period of time has elapsed since the position determination section 12A determines that an object is present on the second floor, and the position determination section 12A determines the position of the object again. In this case, the thinning section 13A may omit the process of determining the position of the object on the first floor and cause the position determination section 12A to determine the position of the object on the second floor. For example, in the case of the three-dimensional space illustrated in FIG. 5, the thinning section 13A causes the position determination section 12A to determine the position of the object with use of a plane that corresponds to the floor of the second floor and is normal to the z-axis.

Thus, to determine the position of the object again, the thinning section 13A causes the position determination section 12A to determine the position of the object with use of a plane which is included in a predetermined area defined with respect to the previously determined position. In other words, the thinning section 13A controls the frequency relating to space at which the position determination section 12A carries out the process of determining the position. Thus, the thinning section 13A can reduce the load of the process of determining the position of an object present in the three-dimensional space.

### (Example 3 of Process Carried Out by Thinning Section 13A)

As yet another example, in a case where the spatial information includes information related to the movement of an object, the thinning section 13A refers to the information related to the movement of the object included in the spatial information, and causes the position determination section 12A to determine the position of the object if it is determined that the object has moved by a predetermined distance or more.

For example, in a case where the spatial information includes information indicating the travel distance of the object, if the thinning section 13A determines that the object has moved by a predetermined distance or more, the thinning section 13A causes the position determination section 12A to determine the position of the object. In other words, if the thinning section 13A determines that the object has not moved by the predetermined distance or more, the position determination section 12A is not made to determine the position of the object.

In this way, if the thinning section 13A determines that the object has moved by a predetermined distance or more, the thinning section 13A causes the position determination section 12A to determine the position of the object. Thus, also in this configuration, the thinning section 13A controls the frequency relating to space at which the position determination section 12A carries out the process of determining the position, so that it is possible to reduce the load of the process of determining the position of an object present in the three-dimensional space.

### (Example 1 of Process Carried Out by Output Section 14A)

As an example, the output section 14A outputs the history of the position determined by the position determination section 12A in a predetermined period. The following will describe the history outputted in the present configuration with reference to FIG. 8. FIG. 8 is a diagram illustrating an example of the history outputted from the output section 14A.

It is assumed that a position determined by the position determination section 12A and stored in the storage section 21 is associated with an object ID and a time. In this case, the output section 14A extracts positions and times associated with an object ID of interest. Then, among the extracted times, a position associated with a time which is included in the predetermined period is determined. As an example, as illustrated in FIG. 8, the output section 14A outputs an image PIC that shows the history of the position of an object of interest (i.e., how the object has moved) in a manner such that the position is distinguishable from others. Further, as illustrated in FIG. 8, the output section 14A may output an image PIC that shows position PT1 at which the object of interest has stayed for a predetermined period of time or more, in a manner such that the position PT1 is distinguishable from others.

Alternatively, the output section 14A may carry out a similar process on a plurality of objects. In this case, the output section 14A may output the history of each object or may output the history of two or more objects.

In this way, the output section 14A outputs the history of the position of the object. This enables the output section 14A to provide a user with information regarding people in a three-dimensional space, such as a route in the three-dimensional space having the large volume of passage of people, a route having the small volume of passage of people, a place where the duration of visit of people is long, and a place where the duration of visit of people is short.

### (Example 2 of Process Carried Out by Output Section 14A)

As another example, the output section 14A outputs at least one selected from the group consisting of the movement of the object, the instruction to the object, and the distance between objects. For example, it may be assumed that the spatial information includes information indicating the instruction from the user to an object.

As an example, in a case where, in the three-dimensional space illustrated in FIG. 3, information indicating an instruction from a user of the object OB2 to make the object OB2 to talk to the object OB1, the output section 14A outputs information indicating that the object OB2 has talked to the object OB1.

As another example, in a case where, in the three-dimensional space illustrated in FIG. 3, information indicating an instruction from a user of the object OB1 to the object OB4 is an instruction to register the product price, the output section 14A outputs information indicating that the object OB1 has carried out an operation of registering the product price to the object OB4.

As yet another example, in the three-dimensional space illustrated in FIG. 3, the output section 14A calculates the distance between the object OB1 and the object OB2 based on the positions of the object OB1 and the object OB2 stored in the storage section 21. Then, the output section 14A outputs information indicating the calculated distance.

In this way, the output section 14A outputs at least one selected from the group consisting of the movement of the object, the instruction to the object, and the distance between objects. Thus, the output section 14A can provide the user with various kinds of information related to objects in the three-dimensional space.

For example, the output section 14A can provide the user with information enabling the user to analyze whether a salesclerk talking to a customer at an appropriate timing if the three-dimensional space is a store, or whether a passenger has performed a boarding procedure with an automatic check-in machine if the three-dimensional space is an airport.

### (Example Advantages of Information Processing Apparatus 1A)

As described in the foregoing, the information processing apparatus 1A determines the position of an object present in the three-dimensional space with reference to the spatial information with use of a plurality of planes, the plurality of planes being normal to respective axes that are independent of each other in the three-dimensional space and being defined to traverse the entirety of the three-dimensional space.

For example, it is assumed that a platform for easily providing service in the three-dimensional space does not notify a user who uses the platform of the position of an object present in the three-dimensional space. Even in this case, the user of the platform can obtain information related to the object. For example, the user of the platform may obtain information that a user who uses the three-dimensional space has entered a predetermined place in the three-dimensional space or information on how much and in what direction a user has moved (e.g., a user has moved for 2 coordinate units in a direction extending along the x-axis).

To determine the position of an object based on such information, the information processing apparatus 1A determines the position of the object with use of, for example, the planes PL1, PL2, and PL3 illustrated in FIG. 5. Thus, compared with a case where the position of an object is determined by making the x-axis, y-axis, and z-axis lie in the three-dimensional space and by determining the x coordinate, the y coordinate, and the z coordinate of the object, the information processing apparatus 1A may reduce the load of the process of determining the position of an object.

### [Software Implementation Example]

Some or all of functions of the information processing apparatuses 1 and 1A (hereinafter, also referred to as “the abovementioned apparatuses”) may be realized by hardware such as an integrated circuit (IC chip) or may be alternatively realized by software.

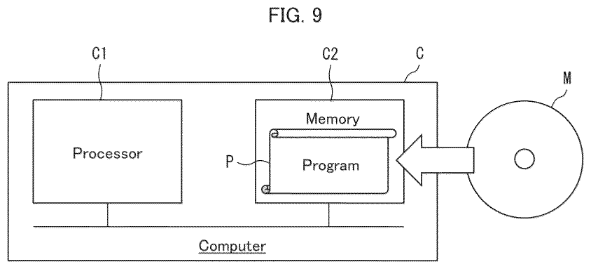

In the latter case, the abovementioned apparatuses are implemented by, for example, a computer that executes instructions of a program that is software implementing the foregoing functions. FIG. 9 illustrates an example of such a computer (hereinafter referred to as “computer C”). FIG. 9 is a block diagram illustrating the hardware configuration of the computer C that functions as the abovementioned apparatuses.

The computer C includes at least one processor C1 and at least one memory C2. The memory C2 stores a program P for causing the computer C to function as the abovementioned apparatuses. The processor C1 of the computer C retrieves the program P from the memory C2 and executes the program P, so that the functions of the abovementioned apparatuses are implemented.

The processor C1 may be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination thereof. The memory C2 may be, for example, a flash memory, a hard disk drive (HDD), a solid state drive (SSD), or a combination of these.

Note that the computer C may further include a random access memory (RAM) in which the program P is loaded in execution of the program P and/or in which various kinds of data are temporarily stored. The computer C may further include a communication interface via which data is transmitted to and received from another apparatus. The computer C may further include an input-output interface for connecting input-output apparatuses such as a keyboard, a mouse, a display and a printer.

The program P can be stored in a non-transitory tangible storage medium M which is readable by the computer C. The storage medium M can be, for example, a tape, a disk, a card, a semiconductor memory, a programmable logic circuit, or the like. The computer C can acquire the program P via the storage medium M. The program P can be transmitted via a transmission medium. The transmission medium can be, for example, a communications network, a broadcast wave, or the like. The computer C can obtain the program P also via such a transmission medium.

Each of the abovementioned functions of the abovementioned apparatuses may be implemented by a single processor provided in a single computer, or by a plurality of processors provided in a single computer and operating in cooperation, or alternatively by a plurality of processors provided in each of the plurality of computers and operating in cooperation. Further, the program for causing the abovementioned apparatuses to implement the abovementioned functions may be stored in a single memory provided in a single computer, or in a plurality of memories provided in a single computer in a distributed manner, or alternatively, in a plurality of memories provided in each of the plurality of computers in a distributed manner.

### [Additional Remark 1]

The present disclosure includes techniques described in supplementary notes below. Note, however, that the present invention is not limited to the techniques described in supplementary notes below, but may be altered in various ways by a skilled person within the scope of the claims.

### [Additional Remark A]

The present disclosure includes techniques described in supplementary notes below. Note, however, that the present invention is not limited to the techniques described in supplementary notes below, but may be altered in various ways by a skilled person within the scope of the claims.

### (Supplementary Note A1)

An information processing apparatus including: spatial information obtaining means for obtaining spatial information that includes information related to a virtual three-dimensional space and related to an object present in the three-dimensional space; and position determination means for determining a position of the object present in the three-dimensional space with reference to the spatial information with use of a plurality of planes, the plurality of planes being normal to respective axes that are independent of each other in the three-dimensional space and being defined to traverse an entirety of the three-dimensional space.

### (Supplementary Note A2)

The information processing apparatus according to Supplementary note A1, wherein the position determination means determines a positional relationship between the object and a plane of the plurality of planes defined to traverse the entirety of the three-dimensional space, to determine the position of the object with respect to the normal of the plane.

### (Supplementary Note A3)

The information processing apparatus according to Supplementary note A1 or A2, further including thinning means for reducing a frequency of a process of determining the position of the object by the position determination means, with reference to the spatial information.

### (Supplementary Note A4)

The information processing apparatus according to Supplementary note A3, wherein the thinning means increases a time interval between runs of the process of determining the position by the position determination means so as to make the time interval longer than a predetermined time interval.

### (Supplementary Note A5)

The information processing apparatus according to Supplementary note A3 or A4, wherein, with regard to the object the position of which is determined, if the position determination means determines a position of the object again after elapse of a predetermined period of time, the thinning means causes the position determination means to determine the position of the object, with use of a plane which is included in a predetermined area defined with respect to the previously determined position.

### (Supplementary Note A6)

The information processing apparatus according to any one of Supplementary notes A1 to A5, further including output means for outputting the position determined by the position determination means.

### (Supplementary Note A7)

The information processing apparatus according to any one of Supplementary notes A1 to A6, further including assignment means for assigning, to each of a plurality of spaces defined by the plurality of planes, identification information for distinguishing the space from others.

### (Supplementary Note A8)

The information processing apparatus according to Supplementary note A7, further including conversion means for converting the position of the object to the identification information, with reference to sensor information outputted from a sensor that detects the object in a real space.

### (Supplementary Note A9)

The information processing apparatus according to any one of Supplementary notes A3 to A5, wherein the spatial information includes information related to movement of the object, and if the thinning means determines that the object moves by a predetermined distance or more with reference to the information related to the movement of the object included in the spatial information, the thinning means causes the position determination means to determine the position of the object.

### (Supplementary Note A10)

The information processing apparatus according to any one of Supplementary notes A3 to A5 and A9, wherein if two or more stories are formed in the three-dimensional space, the thinning means causes the position determination means to determine the position of the object for each of the stories.

### (Supplementary Note A11)

The information processing apparatus according to Supplementary note A6, wherein the output means outputs a history of the position determined by the position determination means in a predetermined period.

### (Supplementary Note A12)

The information processing apparatus according to Supplementary note A6 or A11, wherein the output means outputs at least one selected from the group consisting of the movement of the object, an instruction to the object, and a distance between objects.

### [Additional Remark B]

The present disclosure includes techniques described in supplementary notes below. Note, however, that the present invention is not limited to the techniques described in supplementary notes below, but may be altered in various ways by a skilled person within the scope of the claims.

### (Supplementary Note B1)

An information processing method including:
a spatial information obtaining process in which at least one processor obtains spatial information that includes information related to a virtual three-dimensional space and related to an object present in the three-dimensional space; and
a position determination process in which the at least one processor determines a position of the object present in the three-dimensional space with reference to the spatial information with use of a plurality of planes, the plurality of planes being normal to respective axes that are independent of each other in the three-dimensional space and being defined to traverse an entirety of the three-dimensional space.

### (Supplementary Note B2)

The information processing method according to Supplementary note B1, wherein in the position determination process, the at least one processor determines a positional relationship between the object and a plane of the plurality of planes defined to traverse the entirety of the three-dimensional space, to determine the position of the object with respect to the normal of the plane.

### (Supplementary Note B3)

The information processing method according to Supplementary note B1 or B2, wherein the at least one processor further includes a thinning process of reducing a frequency of a process of determining the position of the object in the position determination process, with reference to the spatial information.

### (Supplementary Note B4)

The information processing method according to Supplementary note B3, wherein in the thinning process, the at least one processor increases a time interval between runs of the process of determining the position in the position determination process so as to make the time interval longer than a predetermined time interval.

### (Supplementary Note B5)

The information processing method according to Supplementary note B3 or B4, wherein, with regard to the object the position of which is determined, if the at least one processor determines, in the position determination process, a position of the object again after elapse of a predetermined period of time, the at least one processor determines, in the thinning process, the position of the object in the position determination process, with use of a plane which is included in a predetermined area defined with respect to the previously determined position.

### (Supplementary Note B6)

The information processing method according to any one of Supplementary notes B1 to B5, wherein the at least one processor further includes an output process of outputting the position determined in the position determination process.

### (Supplementary Note B7)

The information processing method according to any one of Supplementary notes B1 to B6, wherein the at least one processor further includes an assignment process of assigning, to each of a plurality of spaces defined by the plurality of planes, identification information for distinguishing the space from others.

### (Supplementary Note B8)

The information processing method according to Supplementary note B7, wherein the at least one processor further includes a conversion process of converting the position of the object to the identification information, with reference to sensor information outputted from a sensor that detects the object in a real space.

### (Supplementary Note B9)

The information processing method according to any one of Supplementary notes B3 to B5, wherein
the spatial information includes information related to movement of the object, and
if, in the thinning process, the at least one processor determines that the object moves by a predetermined distance or more with reference to the information related to the movement of the object included in the spatial information, the at least one processor determines the position of the object in the position determination process.

### (Supplementary Note B10)

The information processing method according to any one of Supplementary notes B3 to B5 and B9, wherein in the thinning process, if two or more stories are formed in the three-dimensional space, the at least one processor determines, in the position determination process, the position of the object for each of the stories.

### (Supplementary Note B11)

The information processing method according to Supplementary note B6, wherein in the output process, the at least one processor outputs a history of the position determined in the position determination process in a predetermined period.

### (Supplementary Note B12)

The information processing method according to Supplementary note B6 or B11, wherein in the output process, at least one selected from the group consisting of the movement of the object, an instruction to the object, and a distance between objects is outputted.

### [Additional Remark C]

The present disclosure includes techniques described in supplementary notes below. Note, however, that the present invention is not limited to the techniques described in supplementary notes below, but may be altered in various ways by a skilled person within the scope of the claims.

### (Supplementary Note C1)

A program for causing a computer to function as an information processing apparatus, the program causing the computer to function as:
spatial information obtaining means for obtaining spatial information that includes information related to a virtual three-dimensional space and related to an object present in the three-dimensional space; and
position determination means for determining a position of the object present in the three-dimensional space with reference to the spatial information with use of a plurality of planes, the plurality of planes being normal to respective axes that are independent of each other in the three-dimensional space and being defined to traverse an entirety of the three-dimensional space.

### (Supplementary Note C2)

The program according to Supplementary note C1, wherein the position determination means determines a positional relationship between the object and a plane of the plurality of planes defined to traverse the entirety of the three-dimensional space, to determine the position of the object with respect to the normal of the plane.

### (Supplementary Note C3)

The program according to Supplementary note C1 or C2, further causing the computer to function as thinning means for reducing a frequency of a process of determining the position of the object by the position determination means, with reference to the spatial information.

### (Supplementary Note C4)

The program according to Supplementary note C3, wherein the thinning means increases a time interval between runs of the process of determining the position by the position determination means so as to make the time interval longer than a predetermined time interval.

### (Supplementary Note C5)

The program according to Supplementary note C3 or C4, wherein, with regard to the object the position of which is determined, if the position determination means determines a position of the object again after elapse of a predetermined period of time, the thinning means causes the position determination means to determine the position of the object, with use of a plane which is included in a predetermined area defined with respect to the previously determined position.

### (Supplementary Note C6)

The program according to any one of Supplementary notes C1 to C5, further causing the computer to function as output means for outputting the position determined by the position determination means.

### (Supplementary Note C7)

The program according to any one of Supplementary notes C1 to C6, further causing the computer to function as assignment means for assigning, to each of a plurality of spaces defined by the plurality of planes, identification information for distinguishing the space from others.

### (Supplementary Note C8)

The program according to Supplementary note C7, further causing the computer to function as conversion means for converting the position of the object to the identification information, with reference to sensor information outputted from a sensor that detects the object in a real space.

### (Supplementary Note C9)

The program according to any one of Supplementary notes C3 to C5, wherein
the spatial information includes information related to movement of the object, and
if the thinning means determines that the object moves by a predetermined distance or more with reference to the information related to the movement of the object included in the spatial information, the thinning means causes the position determination means to determine the position of the object.

### (Supplementary Note C10)

The program according to any one of Supplementary notes C3 to C5 and C9, wherein if two or more stories are formed in the three-dimensional space, the thinning means causes the position determination means to determine the position of the object for each of the stories.

### (Supplementary Note C11)

The program according to Supplementary note C6, wherein the output means outputs a history of the position determined by the position determination means in a predetermined period.

### (Supplementary Note C12)

The program according to Supplementary note C6 or C11, wherein the output means further outputs at least one selected from the group consisting of the movement of the object, an instruction to the object, and a distance between objects.

### [Additional Remark D]

The present disclosure includes techniques described in supplementary notes below. Note, however, that the present invention is not limited to the techniques described in supplementary notes below, but may be altered in various ways by a skilled person within the scope of the claims.

### (Supplementary Note D1)

An information processing apparatus including at least one processor, the at least one processor carrying out:
a spatial information obtaining process of obtaining spatial information that includes information related to a virtual three-dimensional space and related to an object present in the three-dimensional space; and
a position determination process of determining a position of the object present in the three-dimensional space with reference to the spatial information with use of a plurality of planes, the plurality of planes being normal to respective axes that are independent of each other in the three-dimensional space and being defined to traverse an entirety of the three-dimensional space.

### (Supplementary Note D2)

The information processing apparatus according to Supplementary note D1, wherein in the position determination process, the at least one processor determines a positional relationship between the object and a plane of the plurality of planes defined to traverse the entirety of the three-dimensional space, to determine the position of the object with respect to the normal of the plane.

### (Supplementary Note D3)

The information processing apparatus according to Supplementary note D1 or D2, wherein the at least one processor further carries out a thinning process of reducing a frequency of a process of determining the position of the object in the position determination process, with reference to the spatial information.

### (Supplementary Note D4)

The information processing apparatus according to Supplementary note D3, wherein in the thinning process, the at least one processor increases a time interval between runs of the process of determining the position in the position determination process so as to make the time interval longer than a predetermined time interval.

### (Supplementary Note D5)

The information processing apparatus according to Supplementary note D3 or D4, wherein, with regard to the object the position of which is determined, if the at least one processor determines, in the position determination process, a position of the object again after elapse of a predetermined period of time, the at least one processor determines, in the thinning process, the position of the object in the position determination process, with use of a plane which is included in a predetermined area defined with respect to the previously determined position.

### (Supplementary Note D6)

The information processing apparatus according to any one of Supplementary notes D1 to D5, wherein the at least one processor further carries out an output process of outputting the position determined in the position determination process.

### (Supplementary Note D7)

The information processing apparatus according to any one of Supplementary notes D1 to D6, wherein the at least one processor further carries out an assignment process of assigning, to each of a plurality of spaces defined by the plurality of planes, identification information for distinguishing the space from others.

### (Supplementary Note D8)

The information processing apparatus according to Supplementary note D7, wherein the at least one processor further carries out a conversion process of converting the position of the object to the identification information, with reference to sensor information outputted from a sensor that detects the object in a real space.

### (Supplementary Note D9)

The information processing apparatus according to any one of Supplementary notes D3 to D5, wherein the spatial information includes information related to movement of the object, and if the at least one processor determines, in the thinning process, that the object moves by a predetermined distance or more with reference to the information related to the movement of the object included in the spatial information, the at least one processor determines the position of the object in the position determination process.

### (Supplementary Note D10)

The information processing apparatus according to any one of Supplementary notes D3 to D5 and D9, wherein in the thinning process, if two or more stories are formed in the three-dimensional space, the at least one processor determines, in the position determination process, the position of the object for each of the stories.

### (Supplementary Note D11)

The information processing apparatus according to Supplementary note D6, wherein in the output process, the at least one processor outputs a history of the position determined in the position determination process in a predetermined period.

### (Supplementary Note D12)

The information processing apparatus according to Supplementary note D6 or D11, wherein the output process further outputs at least one selected from the group consisting of the movement of the object, an instruction to the object, and a distance between objects.

### [Additional Remark E]

The present disclosure includes techniques described in supplementary notes below. Note, however, that the present invention is not limited to the techniques described in supplementary notes below, but may be altered in various ways by a skilled person within the scope of the claims.

### (Supplementary Note E1)

A non-transitory storage medium storing a program for causing a computer to function as an information processing apparatus, the program carrying out:
a spatial information obtaining process of obtaining spatial information that includes information related to a virtual three-dimensional space and related to an object present in the three-dimensional space; and
a position determination process of determining a position of the object present in the three-dimensional space with reference to the spatial information with use of a plurality of planes, the plurality of planes being normal to respective axes that are independent of each other in the three-dimensional space and being defined to traverse an entirety of the three-dimensional space.

### REFERENCE SIGNS LIST

1, 1A Information processing apparatus
11, 11A Spatial information obtaining section
12, 12A Position determination section
14A Output section
15A Assignment section
16A Conversion section
OB Object
PL Plane
SP_ID Spatial identification information

1. An information processing apparatus comprising at least one processor, the at least one processor carrying out:
a spatial information obtaining process of obtaining spatial information that includes information related to a virtual three-dimensional space and related to an object present in the three-dimensional space; and
a position determination process of determining a position of the object present in the three-dimensional space with reference to the spatial information with use of a plurality of planes, the plurality of planes being normal to respective axes that are independent of each other in the three-dimensional space and being defined to traverse an entirety of the three-dimensional space.

2. The information processing apparatus according to claim 1, wherein in the position determination process, the at least one processor determines a positional relationship between the object and a plane of the plurality of planes defined to traverse the entirety of the three-dimensional space, to determine the position of the object with respect to the normal of the plane.

3. The information processing apparatus according to claim 1, wherein the at least one processor further carries out a thinning process of reducing a frequency of a process of determining the position of the object in the position determination process, with reference to the spatial information.

4. The information processing apparatus according to claim 3, wherein in the thinning process, the at least one processor increases a time interval between runs of the process of determining the position in the position determination process so as to make the time interval longer than a predetermined time interval.

5. The information processing apparatus according to claim 3, wherein, with regard to the object the position of which is determined, if the at least one processor determines, in the position determination process, a position of the object again after elapse of a predetermined period of time, the at least one processor causes, in the thinning process, the position of the object to be determined in the position determination process, with use of a plane which is included in a predetermined area defined with respect to the previously determined position.

6. The information processing apparatus according to claim 1, wherein the at least one processor further carries out an output process of outputting the position determined in the position determination process.

7. The information processing apparatus according to claim 1, wherein the at least one processor further carries out an assignment process of assigning, to each of a plurality of spaces defined by the plurality of planes, identification information for distinguishing the space from others.

8. The information processing apparatus according to claim 7, wherein the at least one processor further carries out a conversion process of converting the position of the object to the identification information, with reference to sensor information outputted from a sensor that detects the object in a real space.

9. An information processing method comprising:
a spatial information obtaining process in which at least one processor obtains spatial information that includes information related to a virtual three-dimensional space and related to an object present in the three-dimensional space; and
a position determination process in which the at least one processor determines a position of the object present in the three-dimensional space with reference to the spatial information with use of a plurality of planes, the plurality of planes being normal to respective axes that are independent of each other in the three-dimensional space and being defined to traverse an entirety of the three-dimensional space.

10. A non-transitory storage medium storing a program for causing a computer to function as an information processing apparatus, the program carrying out:
a spatial information obtaining process of obtaining spatial information that includes information related to a virtual three-dimensional space and related to an object present in the three-dimensional space; and
a position determination process of determining a position of the object present in the three-dimensional space with reference to the spatial information with use of a plurality of planes, the plurality of planes being normal to respective axes that are independent of each other in the three-dimensional space and being defined to traverse an entirety of the three-dimensional space.
